(19) United States
(12) Patent Application Publication
(10) Pub. No.: US 2024/0080674 A1
(43) Pub. Date: Mar. 7, 2024

(54) METHOD AND SYSTEM TO SUPPORT AUTHENTICATION AND KEY MANAGEMENT FOR APPLICATIONS (AKMA) USING AN ALLOWABILITY INDICATION

(71) Applicant: Telefonaktiebolaget LM Ericsson (publ), Stockholm (SE)

(72) Inventor: Hongxia LONG, Shanghai (CN)

(73) Assignee: Telefonaktiebolaget LM Ericsson (publ), Stockholm (SE)

(21) Appl. No.: 18/271,964

(22) PCT Filed: Oct. 29, 2021
(86) PCT No.: PCT/EP2021/080097

§ 371 Date: Jul. 12, 2023

(30) Foreign Application Priority Data
Jan. 15, 2021 (WO) PCT/CN2021/072114

(51) Int. Cl. H04W 12/72; H04W 12/041; H04W 12/0431; H04W 12/06

(52) U.S. Cl. CPC H04W 12/72; H04W 12/041; H04W 12/0431; H04W 12/06

(57) ABSTRACT

Embodiments include methods, network nodes, storage medium, and instructions to support Authentication and Key Management for Applications (AKMA) using an allowability indication. In one embodiment, a method comprises: transmitting a query that includes an identifier of the subscriber and that requires information on AKMA allowability of the subscriber to a database; and receiving an indication of AKMA allowability of the subscriber responsively, where the indication of AKMA allowability is provided based on retrieval of information for the subscriber stored in the database.

### TECHNICAL FIELD

Embodiments of the invention relate to the field of wireless networking; and more specifically, to support Authentication and Key Management for Applications (AKMA) using an allowability indication.

### BACKGROUND ART

Authentication and Key Management for Applications (AKMA) provides an authentication and key distribution service where access to an application server is based on the user's cellular subscription. In the Third Generation Partnership Project (3GPP), AKMA will support authentication and key management aspects for applications and 3GPP services, including the Internet of Things (IoT) use cases based on 3GPP credentials in a fifth Generation (5G) system. In AKMA, the application provider—denoted by AKMA application function (AF)— delegates the authentication of the AF-user to the home network (FIN) of that user, which is the 3GPP network where that user has a valid subscription. As a result, the application provider has fewer sensitive data to maintain and the subscriber has fewer passwords to remember.

FIG. 1 shows a network model of AKMA architecture including logical entities as well as the interfaces between them. In FIG. 1, AKMA anchor function (AAnF) is a new logical entity required to support the AKMA service. While AAnF is shown as being deployed as a standalone function in FIG. 1, deployments may choose to collocate AAnF with authentication server function (AUSF) or with network exposure function (NEF) according to operators' deployment scenarios.

FIG. 2A shows an AKMA architecture in reference point representation for internal application functions (AFs), and FIG. 2B shows an AKMA architecture in reference point representation for external AFs. Note that in both cases the application function (AF) and UE are peers to support the AKMA service. The AKMA architecture is discussed in 3GPP TS 33.535, entitled “Technical Specification Group Services and System Aspects; Authentication and Key Management for Applications (AKMA) based on 3GPP credentials in the 5G System.”

Yet, in the current AKMA architecture, the unified data management (UDM) entity does not have information on whether AKMA is allowed for a subscriber, thus it can't provide the information upon request.

### SUMMARY OF THE INVENTION

Embodiments include methods to support Authentication and Key Management for Applications (AKMA) using an allowability indication. In one embodiment, a method comprises: transmitting a query that includes an identifier of the subscriber and that requires information on AKMA allowability of the subscriber to a database; and receiving an indication of AKMA allowability of the subscriber responsively, where the indication of AKMA allowability is provided based on retrieval of information for the subscriber stored in the database.

Embodiments include network nodes to support Authentication and Key Management for Applications (AKMA) using an allowability indication. In one embodiment, a network node comprises a processor and machine-readable storage medium that provides instructions that, when executed by the processor, cause the network node to perform: transmitting a query that includes an identifier of the subscriber and that requires information on AKMA allowability of the subscriber to a database; and receiving an indication of AKMA allowability of the subscriber responsively, where the indication of AKMA allowability is provided based on retrieval of information for the subscriber stored in the database.

Embodiments include machine-readable storage media to support Authentication and Key Management for Applications (AKMA) using an allowability indication. In one embodiment, a machine-readable storage medium stores instructions which, when executed, are capable of causing a network nodes to perform operations, comprising: transmitting a query that includes an identifier of the subscriber and that requires information on AKMA allowability of the subscriber to a database; and receiving an indication of AKMA allowability of the subscriber responsively, where the indication of AKMA allowability is provided based on retrieval of information for the subscriber stored in the database.

By implementing embodiments as described, an inquiry party may obtain an indication of AKMA allowability of a subscriber and the authentication of a subscriber (such as UE) to support AKMA functionality may be performed as a part of existing authentication procedures. Such enhancement of the existing authentication procedures facilitates the adaptation of AKMA in wireless networks such as a 5G network.

### BRIEF DESCRIPTION OF THE DRAWINGS

The invention may best be understood by referring to the following description and accompanying drawings that are used to illustrate embodiments of the invention. In the drawings:

FIG. 1 shows a model of AKMA architecture including logical entities.

FIGS. 2A-2B show AKMA architecture in reference point representation for internal and external application functions (AFs), respectively.

FIG. 3 shows operations of primary authentication including AKMA authentication per some embodiments.

FIG. 4 shows operations to provision AKMA allowability per some embodiments.

FIG. 5 shows operations to obtain AKMA allowability per some embodiments.

FIG. 6 shows operations of primary authentication including retrieval of AKMA allowability indication per some embodiments.

FIG. 7 is a flow diagram illustrating operations to support Authentication and Key Management for Applications (AKMA) per some embodiments.

FIG. 8 shows a network node supporting Authentication and Key Management for Applications (AKMA) per some embodiments.

FIG. 9 shows a wireless network per one embodiment of the invention.

FIG. 10 shows a virtualization environment per one embodiment of the invention.

FIG. 11 shows a telecommunication network connected via an intermediate network to a host computer per one embodiment of the invention.

### DETAILED DESCRIPTION

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

### Deriving AKMA Key After Primary Authentication: Example of Desired Operations

AKMA anchor function (AAnF) is the anchor function in a home public land mobile network (HPLMN) that generates the key material to be used between a user equipment (UE) and an application function (AF) and maintains UE AKMA contexts. AAnF enables the AKMA Anchor Key (K_{AKMA}) derivation for AKMA service. Before invoking AKMA service, UE shall have successfully registered to a fifth generation (5G) core network (also referred to as a 5G core), which results in K_{AUSF} being stored at an authentication server function (AUSF) and the UE after a successful 5G primary authentication. Note that while UE in a 5G network is used as an example of a subscriber of a wireless network to use AKMA service, other wireless devices such as the ones shown in FIG. QQ1 may also use embodiments of the present application to use AKMA service in a different wireless network (e.g., a 4G network).

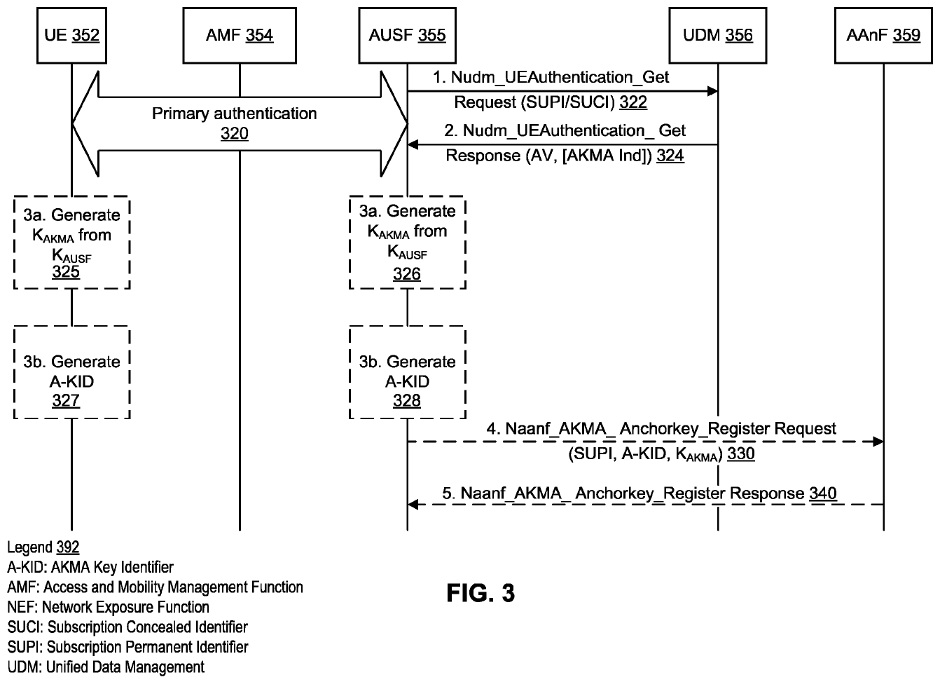

The authentication of the UE to support AKMA functionality does not require a separate procedure. Instead, AKMA may reuse the 5G primary authentication procedure executed (e.g., during the UE Registration) to authenticate the UE. A successful 5G primary authentication results in K_{AUSF} being stored at the AUSF and the UE. FIG. 3 shows operations of primary authentication including AKMA authentication per some embodiments. The primary authentication is performed at reference 320, and the primary authentication, if extended to include authenticating of the UE to support AKMA functionality, includes a UE 352, an Access and Mobility Management Function (AMF) 354, an AUSF 355, a unified data management (UDM) 356, and an AAnF 359. Reference 392 lists legends of acronyms in the figure.

To perform the primary authentication 320, AUSF 355 interacts with UDM 356 in order to fetch authentication information. The authentication information may include subscription credentials such as Authentication and Key Agreement (AKA) authentication vectors (AVs), and the authentication method may use the Nudm_UEAuthentication Get Request service operation. An authentication vector (AV) is a vector that includes at least an expected result (XRES), a network authentication token (AUTN), two keys (CK and IK), and a network challenge (RAND). It is the authentication data to be used during the primary authentication procedure for the purpose of mutual authentication between UE and the network based on the selected authentication method.

As shown, AUSF 355 transmits an authentication request such as Nudm_UEAuthentication Get Request to UDM 356 at Step 1, and the authentication request includes an identity of UE 352. The identity may be in the form of a subscription permanent identifier (SUPI) or subscription concealed identifier (SUCI) as used in a 5G network, but it may also be a global unique temporary identifier (GUTI) in a 4G/5G network or an International Mobile Subscriber Identity (IMSI) in a 4G network.

To authenticate UE 352 to support AKMA functionality, the AUSF needs to get a response back indicating whether AKMA is allowed for UE 352 (e.g., whether AKMA subscription is included in the subscriber's cellular subscription). At reference 324, it is shown that a response returned at Step 2, and the response, Nudm_UEAuthentication_Get Response, includes subscription credentials such as AV, and optional AKMA_Ind, indicating whether AKMA is allowed for UE 352. Note that as explained in more details herein below, such AKMA allowability indication is NOT currently implemented in an UDM such as UDM 356. Embodiments of the present application provide ways to include such AKMA allowability indication in the response at reference 324.

Assuming that the primary authentication 320 is completed successfully and AUSF 355 receives the AKMA allowability indication (AKMA_Ind) from UDM 356, indicating that AKMA is allowable (AKMA_Ind=True), AUSF 355 will store an AUSF key, K_{AUSF}, and generate AKMA materials such as an AKMA Anchor Key (K_{AKMA}) at reference 326 (Step 3a) and an AKMA identifier (A-KID) at reference 328 (Step 3b). Similarly, UE 352 will generate AKMA materials such as a corresponding (K_{AKMA}) at reference 325 (Step 3a) and an AKMA identifier (A-KID) at reference 327 (Step 3b).

After the AKMA materials are generated, AUSF 355 may send the generated AKMA materials such as the K_{AKMA} and A-KID to AAnF 359 together with the UE identity (e.g., SUPI or SUCI) at Reference 330 (Step 4). Reference 330 shows that a registration request such as Naanf_AKMA_KeyRegistration Request service operation including (SUPI, A-KID, K_{AKMA}) is transmitted to AAnF 359, which then stores the latest registration information from AUSF 355 for UE 352.

Note that AUSF 355 does not need to store any AKMA key material after delivery to AAnF 359. Also, when re-authentication runs, AUSF 355 generates a new A-KID and a new K_{AKMA} and sends the newly generated A-KID and K_{AKMA} to AAnF 359. After receiving the newly generated A-KID and K_{AKMA}, AAnF 359 deletes the old A-KID and K_{AKMA} in its registration and stores the newly generated A-KID and K_{AKMA}.

At reference 340 (Step 5), AAnF 359 transmits a response to AUSF 355 and it may use the Naanf_AKMA_AnchorKey_Register Response service operation as shown, indicating whether the registration is successful.

Note that A-KID identifies the K_{AKMA} key of UE 352 and A-KID may be in a Network Access Identifier (NAI) format, e.g., username@realm. The username part shall include the Routing Identifier and the A-TID (AKMA Temporary UE Identifier) and the realm part shall include Home Network Identifier. The A-KID and K_{AKMA} may be derived from K_{AUSF} per standards and thus not discussed in detail herein. Both A-KID and K_{AKMA} can only be refreshed by a new successful primary authentication (such as primary authentication 320).

In the response, the UDM may also indicate to the AUSF whether AKMA Anchor keys need to be generated for the UE.

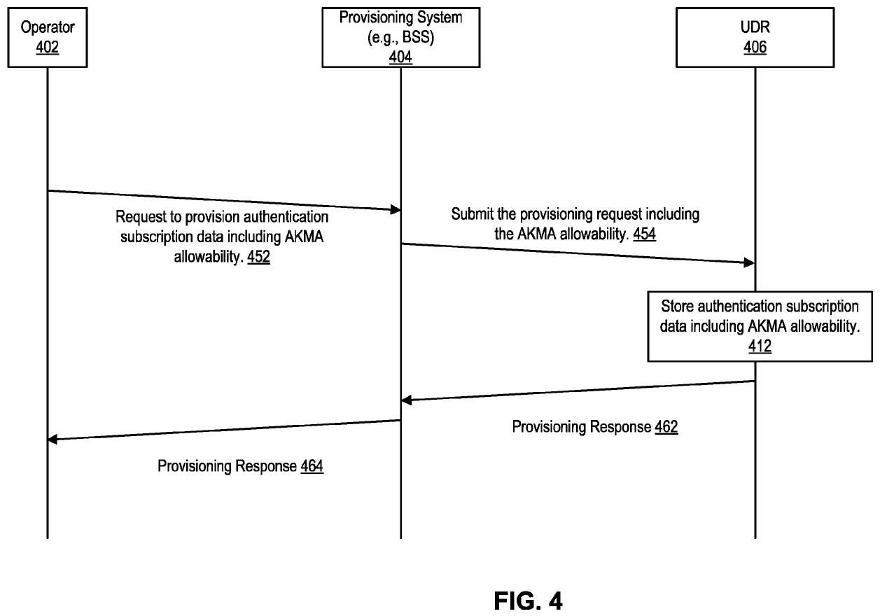

FIG. 3 shows a sequence of desired operations to authenticate a UE for AKMA service by using an extension of the existing primary authentication, yet presently Step 2 does not return any AKMA allowability indication. Thus, the operations in Steps 3 to 5 are shown in dotted lines in FIG. 3, designating the tentative nature of these operations. Embodiments of the present application provide enhancement to the existing primary authentication so that the primary authentication may authenticate the UE for AKMA service as discussed in more details herein (see FIGS. 4 to 6).

Provision and Retrieve AKMA Allowability of a Subscriber

Embodiments of the present application allow a UDM (or another network entity) such as UDM 356 to provide information on AKMA allowability of a subscriber, and the allowability of the subscriber is provisioned and stored in a database. FIG. 4 shows the provision operations of AKMA allowability per some embodiments. The provisioning may be an initial setting of AKMA allowability of a subscriber or an update of the AKMA allowability of the subscriber. The provisioning may be provided to an operator of a wireless network.

At reference 452, the operator issues a request to provision (also referred to as configure) a subscriber's authentication subscription data, and the request to provision includes a request to set AKMA allowability of the subscriber. The provisioning request may be issued through a management interface of the wireless network. The management interface may be a graphics user interface (GUI), command line interface (CLI), or another management interface. The provisioning request may be submitted to a provisioning system 404 such as the operator's business support system (BSS). The provisioning request for the authentication subscription data may indicate requests to set other values as discussed in more details herein below. The provisioning request to set AKMA allowability of the subscriber may be converted to a request to set a Boolean value, where true means AKMA is allowed for the subscriber and false means AKMA is not allowed in some embodiments (or the value may mean the opposite in an alternative embodiment).

At reference 454, the provisioning request may be submitted to a UDR 406. UDR 406 maintains subscription data of subscribers in the wireless network that the operator 402 manages. At reference 412, UDR 406 handles the provisioning request to provision the subscriber's authentication subscription data, and UDR 406 stores the resulting authentication subscription data including the desired allowability of AKMA allowability of the subscriber in UDR 406. Where UDR 406 is shown as an example of an entity in a wireless network at which a database is implemented to store the subscriber's authentication subscription data, including its AKMA allowability, the database may be implemented somewhere else in the wireless network.

At reference 462, UDR 406 provides a response to the provisioning system 404, which in turn provides a response to the operator 402. The operator 402 will learn whether the request to provision authentication subscription data is successful and may retrieve the current authentication subscription data of the subscriber or another subscriber.

The database may store the subscriber's authentication subscription data in a variety of ways. In some embodiments, the subscriber's authentication subscription data have different types, each data type has its own value range. Table 1 shows the subscriber's authentication subscription data per some embodiments.

TABLE 1
Authentication Subscription Data including AKMA Allowability Indication

| Attribute name | Data type | P | Cardinality | Description |
|---|---|---|---|---|
| authenticationMethod | AuthMethod | M | 1 | String containing the Authentication |
| | | | | Method (“5G_AKA”, |
| | | | | “EAP_AKA_PRIME”, “EAP_TLS” . . .) |
| | | | | that shall be used when the UE's device |
| | | | | is 5G capable. |
| | | | | If AV generation for HSS is required in |
| | | | | UDM, this attribute shall take any 5G |
| | | | | AKA-based value (i.e., “5G_AKA” or |
| | | | | “EAP_AKA_PRIME”). |
| encPermanentKey | string | C | 0 . . . 1 | The encrypted value (hexstring) of the |
| | | | | permanent authentication key (K) as |
| | | | | defined in 3GPP standards. |
| | | | | It shall be present if the authentication |
| | | | | method is “5G_AKA” or |
| | | | | “EAP_AKA_PRIME” unless vector |
| | | | | generation is to be done in the HSS. |
| protectionParameterId | string | C | 0 . . . 1 | Identifies a parameter set securely |
| | | | | stored in the UDM (ARPF) that can be |
| | | | | used to decrypt the encPermanentKey |
| | | | | (and encOpcKey or encTopcKey if |
| | | | | present). Values and their meaning are |
| | | | | HPLMN-operator specific. |
| | | | | It shall be present if the authentication |
| | | | | method is “5G_AKA” or |
| | | | | “EAP_AKA_PRIME” unless vector |
| | | | | generation is to be done in the HSS. |
| sequenceNumber | SequenceNumber | C | 0 . . . 1 | String containing the SQN as defined in |
| | | | | 3GPP standards. |
| | | | | It shall be present if the authentication |
| | | | | method is “5G_AKA” or |
| | | | | “EAP_AKA_PRIME” unless vector |
| | | | | generation is to be done in the HSS. |
| authenticationManagementField | string | C | 0 . . . 1 | Hexstring containing the |
| | | | | Authentication management field as |
| | | | | defined in 3GPP standards. |
| | | | | It shall be present if the authentication |
| | | | | method is “5G_AKA” or |
| | | | | “EAP_AKA_PRIME” unless vector |
| | | | | generation is to be done in the HSS. |
| | | | | Pattern: ‘\hat{ }[A-Fa-f0-9]{4}$’ |
| algorithmId | string | C | 0 . . . 1 | Identifies a parameter set securely |
| | | | | stored in the UDM (ARPF) that |
| | | | | provides details on the algorithm and |
| | | | | parameters used to generate |
| | | | | authentication vectors. Values and their |
| | | | | meaning are HPLMN-operator specific. |
| | | | | It shall be present if the authentication |
| | | | | method is “5G_AKA” or |
| | | | | “EAP_AKA_PRIME” unless vector |
| | | | | generation is to be done in the HSS. |
| encOpcKey | string | O | 0 . . . 1 | Hexstring of the encrypted OPC Key. |
| | | | | Presence indicates that the provided |
| | | | | value (decrypted) shall be used instead |
| | | | | of the value derived from OP and K. |
| encTopcKey | string | O | 0 . . . 1 | Hexstring of the encrypted TOPC Key. |
| | | | | Presence indicates that the provided |
| | | | | value (decrypted) shall be used instead |
| | | | | of the value derived from TOP and K. |
| vectorGenerationInHss | boolean | O | 0 . . . 1 | True indicates that the UDM needs to |
| | | | | retrieve an Authentication Vector from |
| | | | | the HSS; |
| | | | | False and absence indicates that vector |
| | | | | generation shall be performed in the |
| | | | | UDM. |
| n5gcDeviceAuthMethod | AuthMethod | O | 0 . . . 1 | String containing the Authentication |
| | | | | Method that shall be used when the |
| | | | | UE's device is Non-5G-Capable behind |
| | | | | Cable RGs in private networks or in |
| | | | | isolated deployment scenarios with |
| | | | | wireline access. |
| | | | | See NOTE. |
| rgAuthenticationInd | boolean | O | 0 . . . 1 | true: indicates that authentication by the |
| | | | | home network is not required if |
| | | | | authentication has been completed by |
| | | | | the W-5GAN. See 3GPP standards. |
| | | | | false (default): otherwise. |
| supi | Supi | C | 0 . . . 1 | If present, this IE shall contain the UE's |
| | | | | SUPI which shall contain an IMSI. |
| | | | | It shall be present if the subscription is |
| | | | | allowed to be identified by a |
| | | | | pseudonym of the SUPI e.g., by a GCI |
| | | | | or GLI that is not the SUPI. |
| akmaAllowed | boolean | O | 0 . . . 1 | This IE indicates whether or not the |
| | | | | subscriber is allowed to use AKMA: |
| | | | | true: subscriber is allowed to use |
| | | | | AKMA |
| | | | | absent or false: subscriber is not |
| | | | | allowed to use AKMA |

Note that the AKMA allowability indication, akmaAllowed, is a data type added to the authentication subscription data as shown in Table 1 (the last row and with the bolded font). The authentication subscription data as shown in Table 1 may be included in a data structure storing information for the subscriber in a database. A subscriber's authentication subscription data may include all mandatory data (indicated with “M” in the third column of Table 1), one or more conditional data (indicated with “C” in the third column of Table 1), and one or more optional data (indicated with “O” in the third column of Table 1). AKMA allowability of a subscriber may be optional (but it may become conditional or mandatory in some embodiments), and it is stored in an information element (IE) as a Boolean data with values being either 0 or 1. When the Boolean value indicates true, it indicates the subscriber is allowed to use AKMA, while when the Boolean value indicates false, it indicates the subscriber is not allowed to use AKMA. When the Boolean value is absent, it may mean that the subscriber is not allowed to use AKMA.

Note that the authentication subscription data of a subscriber shown in Table 1 includes data types known in the art and are thus not discussed in detail. For example, the authentication subscription data includes an authentication method (authenticationMethod), an encryption value of a permanent authentication key (encPermanentKey), a protection parameter identifier (protectionParameterld) that identifies a parameter set that can be used to decrypt the permanent authentication key, a sequence number (sequenceNumber) as defined in standards, an authentication management field (authenticationManagementField), an algorithm identifier (algorithmId) to identify a parameter set that provides details on algorithm and parameters used to generate one or more authentication vectors to authenticate the subscriber, an encrypted operator code (encOpcKey), an encrypted TOPC key, an indication of whether an authentication vector needs to be retrieved (vectorGenerationInHss), an indication of authentication method to be used when the subscriber is not 5G capable (n5gcDeviceAuthMethod), an indication of whether authentication by a home network is required (rgAuthenticationInd), and a subscriber's identifier (SUPI).

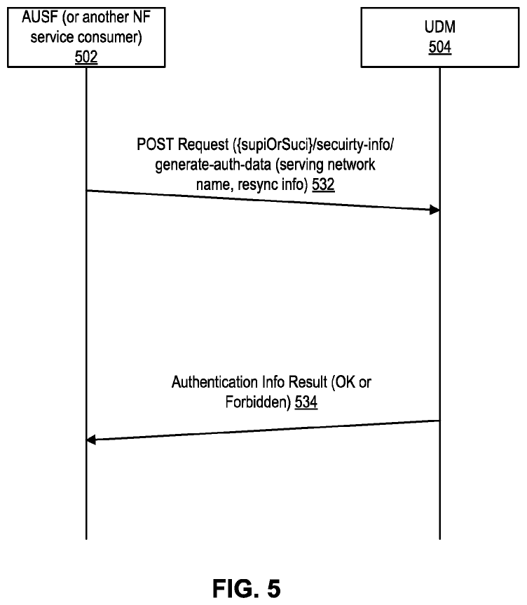

Once the authentication subscription data of a subscriber is provisioned, it may be retrieved by a network function (NF) service consumer. FIG. 5 shows operations to retrieve authentication subscription data including AKMA allowability of a subscriber per some embodiments. The NF service consumer is an AUSF 502 as shown, but it can be a different NF service consumer in an alternative embodiment. AUSF 502 may get authentication subscription data of a subscriber through a POST request issued at reference 532 to the resource representing the subscriber's authentication subscription data. The request may include an identifier of the subscriber (e.g., a SUPI or SUCI), and when a SUCI is provided, UDM 504 calculates the SUPI from the SUCI. The method may be specified as generating authentication data (generate-auth-data), and the serving network name and resynchronization information may be provided in the POST request as well. Note that generating authentication data (generate-auth-data) is a custom method.

At reference 534, UDM 504 provides authentication information result responsively. The result may be an acknowledgement (e.g., HTTP status code 200, OK), with the message body containing the authentication subscription data, including the AKMA allowability indication, as shown in Table 1. AUSF 502 then stores the authentication subscription data for subsequent authentication processing. If AUSF 502 is configured to store K_{AUSF} (e.g., based on its support of steering of roaming protection (SoRProtection), UE parameter protection (UPUProtection) service operations, or deriving AKMA key after primary authentication), AUSF 502 may preserve the K_{AUSF} and related information (e.g., SUPI), optionally including the AKMA allowability indication, after the completion of the primary authentication.

The result may be a failure (e.g., HTTP status code 403, forbidden), where the request is not authorized due to various reasons. For example, the subscriber may not have required authentication subscription data, none of the Closed Access Group identifiers (CAG IDs) in the CAG cell match any of the CAG IDs in the allowed CAG list, access barring or roaming restrictions. The HTTP status code may be returned including additional error information in the response body so that AUSF 502 may know why the requested authentication subscription data, including the AKMA allowability indication, is not returned and proceed accordingly.

Embodiments of this section show the provisioning and retrieval of AKMA allowability of a subscriber. Through the embodiments, an operator may allow a subscriber to use AKMA service, and such allowability may be retrieved in a primary authentication session as shown in FIG. 3, Reference 324 (Step 2) or Reference 532 in FIG. 5. Including the allowability indication in the existing authentication subscription data causes minimum changes to the existing authentication procedures, and it makes implementing AKMA services efficient and with minimum interruption to operator's maintenance operations.

### Exemplary Operations of Primary Authentication with AKMA Authentication

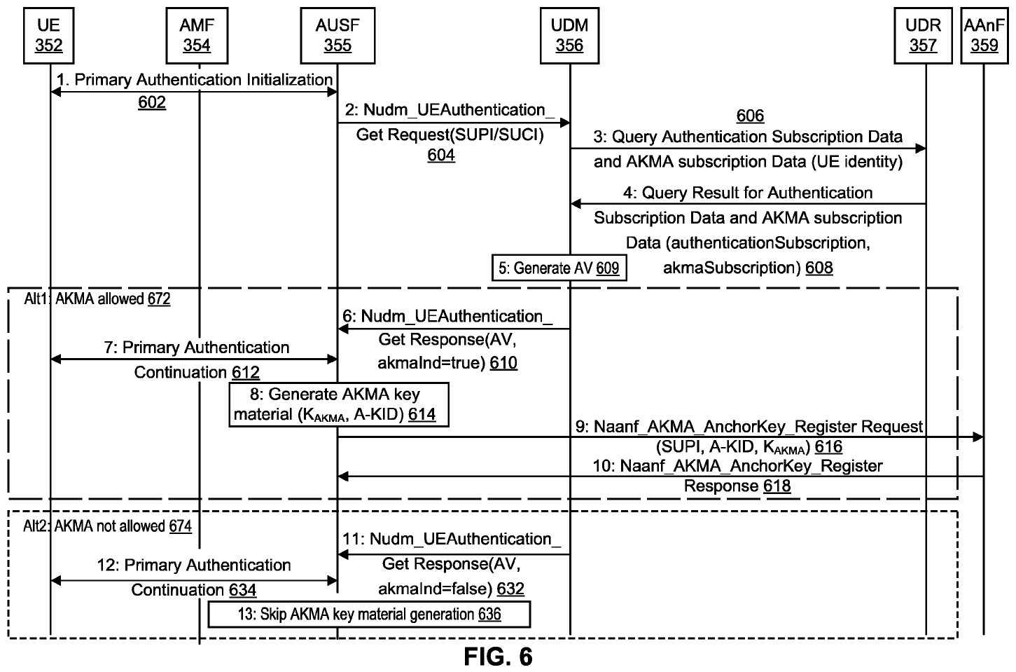

FIG. 6 shows operations of primary authentication including retrieval of AKMA allowability indication per some embodiments. FIG. 6 is similar to FIG. 3, and the entities with the same reference numbers have the same functionalities and/or characteristics. FIG. 6 provides more details about AKMA authentication and the retrieval of AKMA allowability indication, and it includes a unified data repository (UDR) 357, representing an entity in which a database with authentication subscription data including the AKMA allowability indication may be implemented.

At reference 602 (Step 1), a primary authentication procedure is initiated. It may be the initial registration or re-authorization of UE 352. At reference 604 (Step 2), AUSF 355 interacts with UDM 356 during the primary authentication procedure to obtain authentication information such as subscription credentials (e.g., AKA authentication vectors) and authentication method, and the interaction may use the Nudm_UEAuthentication Get Request service operation, similar to FIG. 3 at reference 322.

At reference 606 (Step 3), UDM 356 queries UDR 357 for the subscriber's authentication subscription data to select the authentication method and generate an authentication vector, and the query is also for the subscriber's AKMA subscription data to know whether AKMA is allowed for the subscriber or not. The query includes UE identity (e.g., SUPI, SUCI, or other identities as discussed herein above). Note that the updated subscriber's authentication subscription data in a database, as shown in Table 1, now includes an AKMA allowability indication. Responsively, UDR 357 will query the database for the subscriber's authentication subscription data and get the AKMA allowability indication of the subscriber. For example, the AKMA allowability indication being true indicates that the subscriber is allowed to use AKMA service (i.e., the subscriber has subscripted AKMA service), while being false indicates that the subscriber is not allowed to use AKMA service (i.e., the subscriber has not sub scripted AKMA service).

At reference 608 (Step 4), based on the query to the database, UDR 357 provides the query result to UDM 356 for authentication subscription data and AKMA subscription data (whether AKMA subscription is included in the subscriber's cellular subscription), authenticationSubscription and akmaSubscription, respectively. The former is based on information obtained from the authentication subscription data in Table 1 without the last row, while the latter is based on the AKMA allowability indicator in the last row of Table 1. In one embodiment, UDM 356 indicates to AUSF whether AKMA Key material (e.g., K_{AKMA} and A-KID) need to be generated for the UE after the primary authentication procedure is successfully completed. At reference 609 (Step 5), UDM 356 generates the authentication vector (AV) for the primary authentication.

Steps 6 to 10 are for the first alternative (Alt 1 at reference 672), where the query result indicates that the AKMA is allowed (AKMA Subscription indicating akmaAllowed=True). At reference 610 (Step 6), UDM 356 provides the response for the quest it received at reference 604, and the response includes the AV generated at reference 609 and an AKMA allowability indication (e.g., akmaInd=True). Note that reference 610 (Step 6) of FIG. 6 is to implement reference 324 (Step 2) of FIG. 3, the desired Operation, and the difference is that UDM 356 can now provide the AKMA allowability indication.

At reference 612 (Step 7), the primary authentication continues between UE 352 and AUSF 355. At reference 614 (Step 8), AUSF 335 generates AKMA key material, including the AKMA Anchor Key (K_{AKMA}) and the A-KID from K_{AUSF}, after the primary authentication procedure is successfully completed. Note that reference 614 implements Steps 3a-3b at references 326 and 328 of FIG. 3. Similarly, the UE generates the AKMA Anchor Key (K_{AKMA}) and the A-KID from the K_{AUSF} before initiating communication with an AKMA Application Function (not shown in FIG. 6), and the operation is similar to Steps 3a-3b at references 325 and 327 in FIG. 3.

The operations at references 616 (Step 9) and 618 (Step 10) of FIG. 6 are the same as the operations at reference 330 (Step 4) and 340 (Step 5), and they are not repeated here.

Steps 11 to 13 are for the second alternative (Alt 2 at reference 674), where the query result indicates that the AKMA is not allowed (AKMA Subscription indicating akmaAllowed=False). At reference 632 (Step 11), the response provides the indication, along with the generated AV. At reference 634 (Step 12), the primary authentication continues between UE 352 and AUSF 355. At reference 636 (Step 13), AUSF skips the generation of AKMA key material (in contrast to Step 8).

### Operations Per Some Embodiments

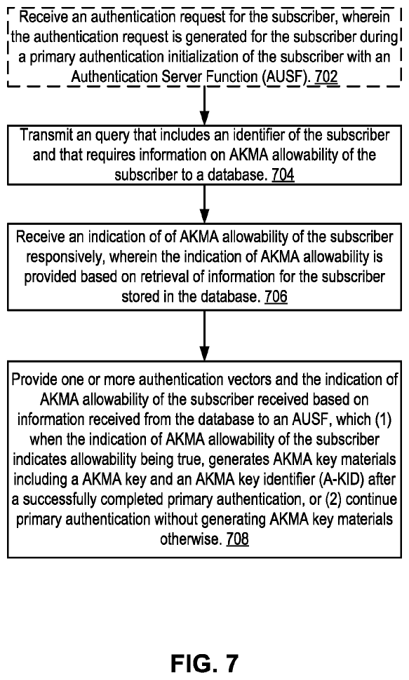

FIG. 7 is a flow diagram illustrating operations to support Authentication and Key Management for Applications (AKMA) per some embodiments. The operations may be implemented in an electronic device to support AKMA in a wireless network, where AKMA provides an authentication and key distribution service to a subscriber of the wireless network to access to an application server based on cellular subscription of the subscriber. The electronic device may implement a unified data management (UDM) entity, policy control function (PCF), network repository function (NRF), service communication proxy (SCP) or a network exposure function (NEF) to perform operations to support AKMA as shown in FIG. 7.

At reference 702, an authentication request for a subscriber is received, where the authentication request is generated for the subscriber during a primary authentication initialization of the subscriber with an Authentication Server Function (AUSF). The operation is discussed herein relating to reference 604.

At reference 704, a query that includes an identifier of the subscriber and that requires information on AKMA allowability of the subscriber is transmitted to a database. The operation is discussed herein relating to references 322 and 606. At reference 706, an indication of AKMA allowability of the subscriber is received responsively, wherein the indication of AKMA allowability is provided based on retrieval of information for the subscriber stored in the database. The operation is discussed herein relating to references 324 and 608.

At reference 708, the one or more authentication vectors and the indication of AKMA allowability of the subscriber are provided to the AUSF, which, when the indication of AKMA allowability of the subscriber indicates allowability being true, generates AKMA key materials including a AKMA key and an AKMA key identifier (A-KID) after a successfully completed primary authentication. Additionally, when the indication of AKMA allowability of the subscriber indicates allowability being false, the AUSF continues primary authentication of the subscriber and without generating the AKMA key materials after the successfully completed primary authentication. The operations are discussed herein relating to the first and second alternatives at references 672 and 674.

In some embodiments, the information for the subscriber stored in the database comprises a Boolean data entry, one value of which indicates that the subscriber is allowed to use AKMA, and an opposite value indicating that the subscriber is not allowed to use AKMA. In some embodiments, the information for the subscriber stored in the database is stored in an Information Element (IE) that is to indicate AKMA allowability of the subscriber. In some embodiments, the information for the subscriber stored in the database is stored as a part of authentication subscription data for the subscriber, wherein the authentication subscription data for the subscriber further comprises an authentication method, an encryption value of a permanent authentication key, a protection parameter identifier that identifies a parameter set that can be used to decrypt the permanent authentication key, and an algorithm identifier to identify a parameter set that provides details on algorithm and parameters used to generate one or more authentication vectors to authenticate the subscriber. These embodiments are discussed herein relating to Table 1.

In some embodiments, the AUSF transmits the AKMA key materials to an AKMA Anchor Function (AAnF), which acknowledges with a register response upon receipt of the AKMA key materials. The operations are discussed herein relating to references 616 and 618.

In some embodiments, the indication of AKMA allowability of the subscriber is provisioned through a management interface of the wireless network. In some embodiments, provisioning of the indication of AKMA allowability of the subscriber uses a business support system (BSS) of the wireless network. The provisioning is discussed herein relating to FIG. 4.

In some embodiments, the database is implemented in a unified data repository (UDR) that stores the information for the subscriber based on which the indication of AKMA allowability is provided.

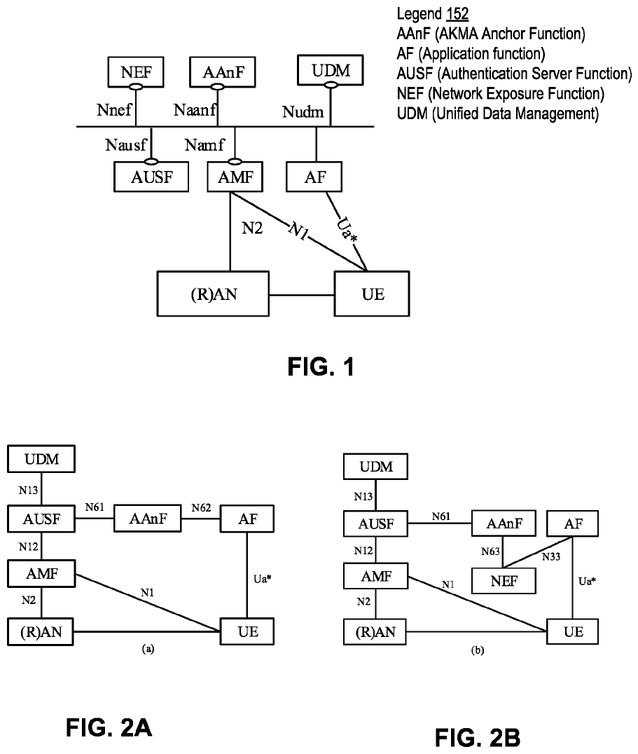

Note that network entity/function discussed relating to FIGS. 1 to 7 may be implemented either as a network element on a dedicated hardware, as a software instance running on a dedicated hardware, or as a virtualized function instantiated on an appropriate platform, e.g., on a cloud infrastructure.

Embodiments of the present application enhance a database storing the authentication subscription data to include information on whether AKMA is allowed for the subscriber. The database may be implemented in a UDR or elsewhere in a wireless network (or in the cloud). Embodiments of the present application provide the service for provisioning system to provision subscriber's AKMA subscription data besides the authentication subscription data to configure whether AKMA is allowed for the subscriber (see FIG. 4 related discussion).

Additionally, other than providing the service for UDM to query subscriber's AKMA subscription data to know whether AKMA is allowed for the subscriber besides the authentication subscription data, embodiments may provide the same service for PCF, NRF, SCP, NEF, or another network function. In these embodiments, the other network function stands and perform the operations of UDM as shown in Figures such as FIGS. 3 and 6.

### Terms

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

References in the specification to “one embodiment,” “an embodiment,” “an example embodiment,” and so forth, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The description and claims may use the terms “coupled” and “connected,” along with their derivatives. These terms are not intended as synonyms for each other. “Coupled” is used to indicate that two or more elements, which may or may not be in direct physical or electrical contact with each other, co-operate or interact with each other. “Connected” is used to indicate the establishment of wireless or wireline communication between two or more elements that are coupled with each other. A “set,” as used herein, refers to any positive whole number of items including one item.

An electronic device stores and transmits (internally and/or with other electronic devices over a network) code (which is composed of software instructions and which is sometimes referred to as a computer program code or a computer program) and/or data using machine-readable media (also called computer-readable media), such as machine-readable storage media (e.g., magnetic disks, optical disks, solid state drives, read only memory (ROM), flash memory devices, phase change memory) and machine-readable transmission media (also called a carrier) (e.g., electrical, optical, radio, acoustical, or other form of propagated signals—such as carrier waves, infrared signals). Thus, an electronic device (e.g., a computer) includes hardware and software, such as a set of one or more processors (e.g., of which a processor is a microprocessor, controller, microcontroller, central processing unit, digital signal processor, application specific integrated circuit (ASIC), field programmable gate array (FPGA), other electronic circuitry, or a combination of one or more of the preceding) coupled to one or more machine-readable storage media to store code for execution on the set of processors and/or to store data. For instance, an electronic device may include non-volatile memory containing the code since the non-volatile memory can persist code/data even when the electronic device is turned off (when power is removed). When the electronic device is turned on, that part of the code that is to be executed by the processor(s) of the electronic device is typically copied from the slower non-volatile memory into volatile memory (e.g., dynamic random-access memory (DRAM), static random-access memory (SRAM)) of the electronic device. Typical electronic devices also include a set of one or more physical network interface(s) (NI(s)) to establish network connections (to transmit and/or receive code and/or data using propagating signals) with other electronic devices. For example, the set of physical NIs (or the set of physical NI(s) in combination with the set of processors executing code) may perform any formatting, coding, or translating to allow the electronic device to send and receive data whether over a wired and/or a wireless connection. In some embodiments, a physical NI may comprise radio circuitry capable of (1) receiving data from other electronic devices over a wireless connection and/or (2) sending data out to other devices through a wireless connection. This radio circuitry may include transmitter(s), receiver(s), and/or transceiver(s) suitable for radio frequency communication. The radio circuitry may convert digital data into a radio signal having the proper parameters (e.g., frequency, timing, channel, bandwidth, and so forth). The radio signal may then be transmitted through antennas to the appropriate recipient(s). In some embodiments, the set of physical NI(s) may comprise network interface controller(s) (NICs), also known as a network interface card, network adapter, or local area network (LAN) adapter. The NIC(s) may facilitate in connecting the electronic device to other electronic devices allowing them to communicate with wire through plugging in a cable to a physical port connected to an NIC. One or more parts of an embodiment of the invention may be implemented using different combinations of software, firmware, and/or hardware.

A wireless communication network (or “wireless network,” and the two terms are used interchangeably) is a network of electronic devices communicating using radio waves (electromagnetic waves within the frequencies 30 KHz-300 GHz). The wireless communications may follow wireless communication standards, such as new radio (NR), LTE-Advanced (LTE-A), LTE, wideband code division multiple access (WCDMA), High-Speed Packet Access (HSPA). Furthermore, the communications between the electronic devices such as network devices and terminal devices in the wireless communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G) communication protocols, and/or any other protocols either currently known or to be developed in the future. While LTE and NR are used as examples to describe embodiments of the invention, the invention may apply to other wireless communication networks, including LTE operating in unlicensed spectrums, Multefire systems, and IEEE 802.11 systems.

A network node or node (also referred to as a network device (ND), and these terms are used interchangeably in this disclosure) is an electronic device in a wireless communication network via which a wireless device accesses the network and receives services therefrom. One type of network node may refer to a base station (BS) or an access point (AP), for example, a node B (NodeB or NB), an evolved NodeB (eNodeB or eNB), a next generation node B (gNB), a remote radio unit (RRU), a radio header (RH), a remote radio head (RRH), a relay, and a low power node such as a femtocell and a picocell.

A wireless device (WD) may access a wireless communication network and receive services from the wireless communication network through a network node. A wireless device may also be referred to as a terminal device, and the two terms are used interchangeably in this disclosure. A wireless device may be a subscriber station (SS), a portable subscriber Station, a mobile station (MS), an access terminal (AT), or other end user devices. An end user device (also referred to as end device, and the two terms are used interchangeably) may be one of a mobile phone, a cellular phone, a smart phone, a tablet, a wearable device, a personal digital assistant (PDA), a portable computer, an image capture terminal device (e.g., a digital camera), a gaming terminal device, a music storage and playback appliance, a smart appliance, a vehicle-mounted wireless terminal device, a smart speaker, and an Internet of Things (IoT) device. Terminal devices may be coupled (e.g., through customer premise equipment coupled to an access network (wired or wirelessly)) to edge NDs, which are coupled (e.g., through one or more core NDs) to other edge NDs, which are coupled to electronic devices acting as servers.

A Network Node Implementing Embodiments of the Invention

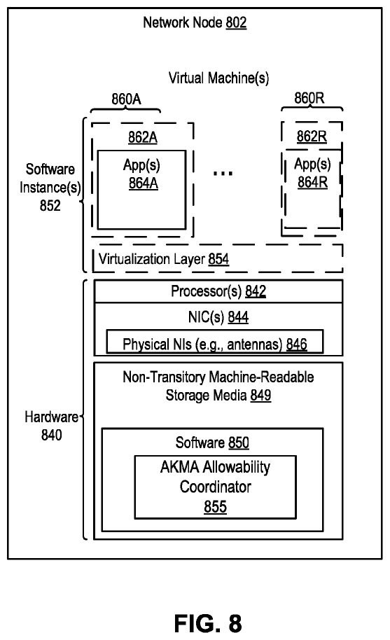

FIG. 8 shows a network node supporting Authentication and Key Management for Applications (AKMA) per some embodiments. The network node 802 may be implemented using custom application—specific integrated—circuits (ASICs) as processors and a special-purpose operating system (OS), or common off-the-shelf (COTS) processors and a standard OS. In some embodiments, the network node 802 implements one or more logical entities of the AKMA architecture shown in FIGS. 1 to 3 and 6 to interact with a wireless device (UE). For example, the network node 802 may implement one or more of AUSF, UDM, UDR, AAnF, NEF, and AMF.

The network node 802 includes hardware 840 comprising a set of one or more processors 842 (which are typically COTS processors or processor cores or ASICs) and physical NIs 846, as well as non-transitory machine-readable storage media 849 having stored therein software 850. During operation, the one or more processors 842 may execute the software 850 to instantiate one or more sets of one or more applications 864A-R. While one embodiment does not implement virtualization, alternative embodiments may use different forms of virtualization. For example, in one such alternative embodiment, the virtualization layer 854 represents the kernel of an operating system (or a shim executing on a base operating system) that allows for the creation of multiple instances 862A-R called software containers that may each be used to execute one (or more) of the sets of applications 864A-R. The multiple software containers (also called virtualization engines, virtual private servers, or jails) are user spaces (typically a virtual memory space) that are separate from each other and separate from the kernel space in which the operating system is run. The set of applications running in a given user space, unless explicitly allowed, cannot access the memory of the other processes. In another such alternative embodiment, the virtualization layer 854 represents a hypervisor (sometimes referred to as a virtual machine monitor (VMM)) or a hypervisor executing on top of a host operating system, and each of the sets of applications 864A-R run on top of a guest operating system within an instance 862A-R called a virtual machine (which may in some cases be considered a tightly isolated form of software container) that run on top of the hypervisor—the guest operating system and application may not know that they are running on a virtual machine as opposed to running on a “bare metal” host electronic device, or through para-virtualization the operating system and/or application may be aware of the presence of virtualization for optimization purposes. In yet other alternative embodiments, one, some, or all of the applications are implemented as unikernel(s), which can be generated by compiling directly with an application only a limited set of libraries (e.g., from a library operating system (LibOS) including drivers/libraries of OS services) that provide the particular OS services needed by the application. As a unikernel can be implemented to run directly on hardware 840, directly on a hypervisor (in which case the unikernel is sometimes described as running within a LibOS virtual machine), or in a software container, embodiments can be implemented fully with unikernels running directly on a hypervisor represented by virtualization layer 854, unikernels running within software containers represented by instances 862A-R, or as a combination of unikernels and the above-described techniques (e.g., unikernels and virtual machines both run directly on a hypervisor, unikernels, and sets of applications that are run in different software containers).

The software 850 contains an AKMA allowability coordinator 855 that performs operations described with reference to FIGS. 1-7. For example, the AKMA allowability coordinator 855 may perform the operations of a UDM, a UDR, a AUSF or a combination two or more of the UDM, the UDR, and the AUSF discussed herein. The AKMA allowability coordinator 855 may be instantiated within the applications 864A-R. The instantiation of the one or more sets of one or more applications 864A-R, as well as virtualization if implemented, are collectively referred to as software instance(s) 852. Each set of applications 864A-R, corresponding virtualization construct (e.g., instance 862A-R) if implemented, and that part of the hardware 840 that executes them (be it hardware dedicated to that execution and/or time slices of hardware temporally shared), forms a separate virtual electronic device 860A-R.

A network interface (NI) may be physical or virtual. In the context of IP, an interface address is an IP address assigned to an NI, be it a physical NI or virtual NI. A virtual NI may be associated with a physical NI, with another virtual interface, or stand on its own (e.g., a loopback interface, a point-to-point protocol interface). A NI (physical or virtual) may be numbered (a NI with an IP address) or unnumbered (a NI without an IP address).

### A Wireless Network in Accordance with Some Embodiments

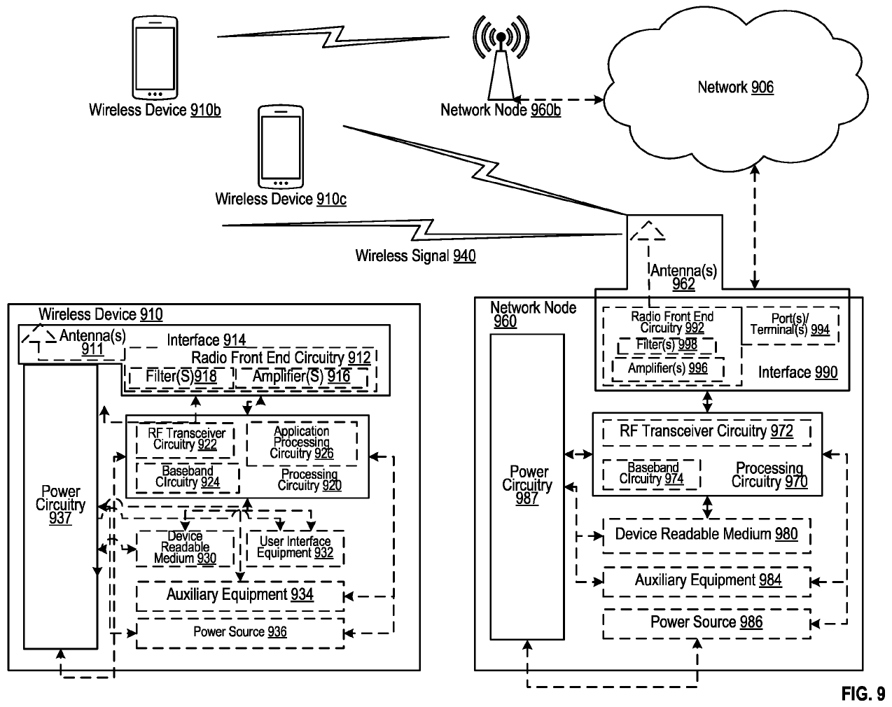

Although the subject matter described herein may be implemented in any appropriate type of system using any suitable components, the embodiments disclosed herein are described in relation to a wireless network, such as the example wireless network illustrated in FIG. 9. For simplicity, the wireless network of FIG. 9 only depicts network 906, network nodes 961 and 960b, and WDs 910, 910b, and 910c. In practice, a wireless network may further include any additional elements suitable to support communication between wireless devices or between a wireless device and another communication device, such as a landline telephone, a service provider, or any other network node or end device. Of the illustrated components, network node 960 and wireless device (WD) 910 are depicted with additional detail. The wireless network may provide communication and other types of services to one or more wireless devices to facilitate the wireless devices' access to and/or use of the services provided by, or via, the wireless network. In one embodiment, one or more of the network nodes 961 and 960b, WDs 910, 910b, and 910c are installed in a fixed location thus the wireless network operates as a fixed wireless network.

The wireless network 906 may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave, and/or ZigBee standards.

Network 906 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 960 and WD 910 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

Network node 960 and WD 910 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs), and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay.

A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 9, network node 960 includes processing circuitry 970, device readable medium 980, interface 990, auxiliary equipment 984, power source 986, power circuitry 987, and antenna 962. Although network node 960 illustrated in the example wireless network of FIG. 9 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 960 are depicted as single boxes located within a larger box, or nested within multiple boxes, in practice, a network node may comprise multiple different physical components that make up a single illustrated component (e.g., device readable medium 980 may comprise multiple separate hard drives as well as multiple RAM modules).

Similarly, network node 960 may be composed of multiple physically separate components (e.g., a NodeB component and a RNC component, or a BTS component and a BSC component, etc.), which may each have their own respective components. In certain scenarios in which network node 960 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, network node 960 may be configured to support multiple radio access technologies (RATs). In such embodiments, some components may be duplicated (e.g., separate device readable medium 980 for the different RATs) and some components may be reused (e.g., the same antenna 962 may be shared by the RATs). Network node 960 may also include multiple sets of the various illustrated components for different wireless technologies integrated into network node 960, such as, for example, GSM, WCDMA, LTE, NR, WiFi, or Bluetooth wireless technologies. These wireless technologies may be integrated into the same or different chip or set of chips and other components within network node 960.

Processing circuitry 970 is configured to perform any determining, calculating, or similar operations (e.g., certain obtaining operations) described herein as being provided by a network node. These operations performed by processing circuitry 970 may include processing information obtained by processing circuitry 970 by, for example, converting the obtained information into other information, comparing the obtained information or converted information to information stored in the network node, and/or performing one or more operations based on the obtained information or converted information, and as a result of said processing making a determination.

Processing circuitry 970 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other network node 960 components, such as device readable medium 980, network node 960 functionality. For example, processing circuitry 970 may execute instructions stored in device readable medium 980 or in memory within processing circuitry 970. Such functionality may include providing any of the various wireless features, functions, or benefits discussed herein. In some embodiments, processing circuitry 970 may include a system on a chip (SoC).

In some embodiments, processing circuitry 970 may include one or more of radio frequency (RF) transceiver circuitry 972 and baseband processing circuitry 974. In some embodiments, radio frequency (RF) transceiver circuitry 972 and baseband processing circuitry 974 may be on separate chips (or sets of chips), boards, or units, such as radio units and digital units. In alternative embodiments, part or all of RF transceiver circuitry 972 and baseband processing circuitry 974 may be on the same chip or set of chips, boards, or units.

In certain embodiments, some or all of the functionality described herein as being provided by a network node, base station, eNB or other such network device may be performed by processing circuitry 970 executing instructions stored on device readable medium 980 or memory within processing circuitry 970. In alternative embodiments, some or all of the functionalities may be provided by processing circuitry 970 without executing instructions stored on a separate or discrete device readable medium, such as in a hard-wired manner. In any of those embodiments, whether executing instructions stored on a device readable storage medium or not, processing circuitry 970 can be configured to perform the described functionality. The benefits provided by such functionality are not limited to processing circuitry 970 alone or to other components of network node 960, but they are enjoyed by network node 960 as a whole, and/or by end users and the wireless network generally.

Device readable medium 980 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD), or a Digital Video Disk (DVD)), and/or any other volatile or non-volatile, non-transitory device readable and/or computer-executable memory devices that store information, data, and/or instructions that may be used by processing circuitry 970. Device readable medium 980 may store any suitable instructions, data, or information, including a computer program, software, an application including one or more of logic, rules, code, tables, etc., and/or other instructions capable of being executed by processing circuitry 970 and utilized by network node 960. Device readable medium 980 may be used to store any calculations made by processing circuitry 970 and/or any data received via interface 990. In some embodiments, processing circuitry 970 and device readable medium 980 may be considered to be integrated. In some embodiments, the device readable medium 980 may comprise the AKMA allowability coordinator 855 discussed herein above.

Interface 990 is used in the wired or wireless communication of signaling and/or data between network node 960, network 906, and/or WDs 910. As illustrated, interface 990 comprises port(s)/terminal(s) 994 to send and receive data, for example to and from network 906 over a wired connection. Interface 990 also includes radio front end circuitry 992 that may be coupled to, or in certain embodiments a part of, antenna 962. Radio front end circuitry 992 comprises filters 998 and amplifiers 996. Radio front end circuitry 992 may be connected to antenna 962 and processing circuitry 970. Radio front end circuitry may be configured to condition signals communicated between antenna 962 and processing circuitry 970. Radio front end circuitry 992 may receive digital data that is to be sent out to other network nodes or WDs via a wireless connection. Radio front end circuitry 992 may convert the digital data into a radio signal having the appropriate channel and bandwidth parameters using a combination of filters 998 and/or amplifiers 996. The radio signal may then be transmitted via antenna 962. Similarly, when receiving data, antenna 962 may collect radio signals which are then converted into digital data by radio front end circuitry 992. The digital data may be passed to processing circuitry 970. In other embodiments, the interface may comprise different components and/or different combinations of components.

In certain alternative embodiments, network node 960 may not include separate radio front end circuitry 992; instead, processing circuitry 970 may comprise radio front end circuitry and may be connected to antenna 962 without separate radio front end circuitry 992. Similarly, in some embodiments, all or some of RF transceiver circuitry 972 may be considered a part of interface 990. In still other embodiments, interface 990 may include one or more ports or terminals 994, radio front end circuitry 992, and RF transceiver circuitry 972, as part of a radio unit (not shown), and interface 990 may communicate with baseband processing circuitry 974, which is part of a digital unit (not shown).

Antenna 962 may include one or more antennas, or antenna arrays, configured to send and/or receive wireless signals. Antenna 962 may be coupled to radio front end circuitry 992 and may be any type of antenna capable of transmitting and receiving data and/or signals wirelessly. In some embodiments, antenna 962 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line-of-sight antenna used to transmit/receive radio signals in a relatively straight line. In some instances, the use of more than one antenna may be referred to as MIMO. In certain embodiments, antenna 962 may be separate from network node 960 and may be connectable to network node 960 through an interface or port.

Antenna 962, interface 990, and/or processing circuitry 970 may be configured to perform any receiving operations and/or certain obtaining operations described herein as being performed by a network node. Any information, data, and/or signals may be received from a wireless device, another network node, and/or any other network equipment. Similarly, antenna 962, interface 990, and/or processing circuitry 970 may be configured to perform any transmitting operations described herein as being performed by a network node. Any information, data, and/or signals may be transmitted to a wireless device, another network node, and/or any other network equipment.

Power circuitry 987 may comprise, or be coupled to, power management circuitry and is configured to supply the components of network node 960 with power for performing the functionality described herein. Power circuitry 987 may receive power from power source 986. Power source 986 and/or power circuitry 987 may be configured to provide power to the various components of network node 960 in a form suitable for the respective components (e.g., at a voltage and current level needed for each respective component). Power source 986 may either be included in, or external to, power circuitry 987 and/or network node 960. For example, network node 960 may be connectable to an external power source (e.g., an electricity outlet) via an input circuitry or interface such as an electrical cable, whereby the external power source supplies power to power circuitry 987. As a further example, power source 986 may comprise a source of power in the form of a battery or battery pack which is connected to, or integrated in, power circuitry 987. The battery may provide backup power should the external power source fail. Other types of power sources, such as photovoltaic devices, may also be used.

Alternative embodiments of network node 960 may include additional components beyond those shown in FIG. 9 that may be responsible for providing certain aspects of the network node's functionality, including any of the functionality described herein and/or any functionality necessary to support the subject matter described herein. For example, network node 960 may include user interface equipment to allow input of information into network node 960 and to allow output of information from network node 960. This may allow a user to perform diagnostic, maintenance, repair, and other administrative functions for network node 960.

As used herein, wireless device (WD) refers to a device capable, configured, arranged, and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (Von)) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE), a vehicle-mounted wireless terminal device, etc. A WD may support device-to-device (D2D) communication, for example by implementing a 3GPP standard for si del ink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a WD may represent a machine or other device that performs monitoring and/or measurements and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-IoT) standard. Particular examples of such machines or devices are sensors, metering devices such as power meters, industrial machinery, or home or personal appliances (e.g., refrigerators, televisions, etc.), personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 910 includes antenna 911, interface 914, processing circuitry 920, device readable medium 930, user interface equipment 932, auxiliary equipment 934, power source 936, and power circuitry 937. WD 910 may include multiple sets of one or more of the illustrated components for different wireless technologies supported by WD 910, such as, for example, GSM, WCDMA, LTE, NR, WiFi, WiMAX, or Bluetooth wireless technologies, just to mention a few. These wireless technologies may be integrated into the same or different chips or set of chips as other components within WD 910.

Antenna 911 may include one or more antennas or antenna arrays, configured to send and/or receive wireless signals, and is connected to interface 914. In certain alternative embodiments, antenna 911 may be separate from WD 910 and be connectable to WD 910 through an interface or port. Antenna 911, interface 914, and/or processing circuitry 920 may be configured to perform any receiving or transmitting operations described herein as being performed by a WD. Any information, data and/or signals may be received from a network node and/or another WD. In some embodiments, radio front end circuitry and/or antenna 911 may be considered an interface.

As illustrated, interface 914 comprises radio front end circuitry 912 and antenna 911. Radio front end circuitry 912 comprise one or more filters 918 and amplifiers 916. Radio front end circuitry 912 is connected to antenna 911 and processing circuitry 920 and is configured to condition signals communicated between antenna 911 and processing circuitry 920. Radio front end circuitry 912 may be coupled to or a part of antenna 911. In some embodiments, WD 910 may not include separate radio front end circuitry 912; rather, processing circuitry 920 may comprise radio front end circuitry and may be connected to antenna 911. Similarly, in some embodiments, some or all of RF transceiver circuitry 922 may be considered a part of interface 914. Radio front end circuitry 912 may receive digital data that is to be sent out to other network nodes or WDs via a wireless connection. Radio front end circuitry 912 may convert the digital data into a radio signal having the appropriate channel and bandwidth parameters using a combination of filters 918 and/or amplifiers 916. The radio signal may then be transmitted via antenna 911. Similarly, when receiving data, antenna 911 may collect radio signals which are then converted into digital data by radio front end circuitry 912. The digital data may be passed to processing circuitry 920. In other embodiments, the interface may comprise different components and/or different combinations of components.

Processing circuitry 920 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 910 components, such as device readable medium 930, WD 910 functionality. Such functionality may include providing any of the various wireless features or benefits discussed herein. For example, processing circuitry 920 may execute instructions stored in device readable medium 930 or in memory within processing circuitry 920 to provide the functionality disclosed herein.

As illustrated, processing circuitry 920 includes one or more of RF transceiver circuitry 922, baseband processing circuitry 924, and application processing circuitry 926. In other embodiments, the processing circuitry may comprise different components and/or different combinations of components. In certain embodiments processing circuitry 920 of WD 910 may comprise a SoC. In some embodiments, RF transceiver circuitry 922, baseband processing circuitry 924, and application processing circuitry 926 may be on separate chips or sets of chips. In alternative embodiments, part or all of baseband processing circuitry 924 and application processing circuitry 926 may be combined into one chip or set of chips, and RF transceiver circuitry 922 may be on a separate chip or set of chips. In still alternative embodiments, part or all of RF transceiver circuitry 922 and baseband processing circuitry 924 may be on the same chip or set of chips, and application processing circuitry 926 may be on a separate chip or set of chips. In yet other alternative embodiments, part or all of RF transceiver circuitry 922, baseband processing circuitry 924, and application processing circuitry 926 may be combined in the same chip or set of chips. In some embodiments, RF transceiver circuitry 922 may be a part of interface 914. RF transceiver circuitry 922 may condition RF signals for processing circuitry 920.

In certain embodiments, some or all of the functionality described herein as being performed by a WD may be provided by processing circuitry 920 executing instructions stored on device readable medium 930, which in certain embodiments may be a computer-readable storage medium. In alternative embodiments, some or all of the functionality may be provided by processing circuitry 920 without executing instructions stored on a separate or discrete device readable storage medium, such as in a hard-wired manner. In any of those particular embodiments, whether executing instructions stored on a device readable storage medium or not, processing circuitry 920 can be configured to perform the described functionality. The benefits provided by such functionality are not limited to processing circuitry 920 alone or to other components of WD 910, but are enjoyed by WD 910 as a whole, and/or by end users and the wireless network generally.

Processing circuitry 920 may be configured to perform any determining, calculating, or similar operations (e.g., certain obtaining operations) described herein as being performed by a WD. These operations, as performed by processing circuitry 920, may include processing information obtained by processing circuitry 920 by, for example, converting the obtained information into other information, comparing the obtained information or converted information to information stored by WD 910, and/or performing one or more operations based on the obtained information or converted information, and as a result of said processing making a determination.

Device readable medium 930 may be operable to store a computer program, software, an application including one or more of logic, rules, code, tables, etc., and/or other instructions capable of being executed by processing circuitry 920. Device readable medium 930 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 920. In some embodiments, processing circuitry 920 and device readable medium 930 may be considered to be integrated.

User interface equipment 932 may provide components that allow for a human user to interact with WD 910. Such interaction may be of many forms, such as visual, audial, tactile, etc. User interface equipment 932 may be operable to produce output to the user and to allow the user to provide input to WD 910. The type of interaction may vary depending on the type of user interface equipment 932 installed in WD 910. For example, if WD 910 is a smart phone, the interaction may be via a touch screen; if WD 910 is a smart meter, the interaction may be through a screen that provides usage (e.g., the number of gallons used) or a speaker that provides an audible alert (e.g., if smoke is detected). User interface equipment 932 may include input interfaces, devices and circuits, and output interfaces, devices and circuits. User interface equipment 932 is configured to allow input of information into WD 910, and is connected to processing circuitry 920 to allow processing circuitry 920 to process the input information. User interface equipment 932 may include, for example, a microphone, a proximity or other sensor, keys/buttons, a touch display, one or more cameras, a USB port, or other input circuitry. User interface equipment 932 is also configured to allow output of information from WD 910, and to allow processing circuitry 920 to output information from WD 910. User interface equipment 932 may include, for example, a speaker, a display, vibrating circuitry, a USB port, a headphone interface, or other output circuitry. Using one or more input and output interfaces, devices, and circuits, of user interface equipment 932, WD 910 may communicate with end users and/or the wireless network, and allow them to benefit from the functionality described herein.

Auxiliary equipment 934 is operable to provide more specific functionality which may not be generally performed by WDs. This may comprise specialized sensors for doing measurements for various purposes, interfaces for additional types of communication such as wired communications etc. The inclusion and type of components of auxiliary equipment 934 may vary depending on the embodiment and/or scenario.

Power source 936 may, in some embodiments, be in the form of a battery or battery pack. Other types of power sources, such as an external power source (e.g., an electricity outlet), photovoltaic devices or power cells, may also be used. WD 910 may further comprise power circuitry 937 for delivering power from power source 936 to the various parts of WD 910 which need power from power source 936 to carry out any functionality described or indicated herein. Power circuitry 937 may in certain embodiments comprise power management circuitry. Power circuitry 937 may additionally or alternatively be operable to receive power from an external power source; in which case WD 910 may be connectable to the external power source (such as an electricity outlet) via input circuitry or an interface such as an electrical power cable. Power circuitry 937 may also in certain embodiments be operable to deliver power from an external power source to power source 936. This may be, for example, for the charging of power source 936. Power circuitry 937 may perform any formatting, converting, or other modification to the power from power source 936 to make the power suitable for the respective components of WD 910 to which power is supplied.

### Virtualization Environment in Accordance with Some Embodiments

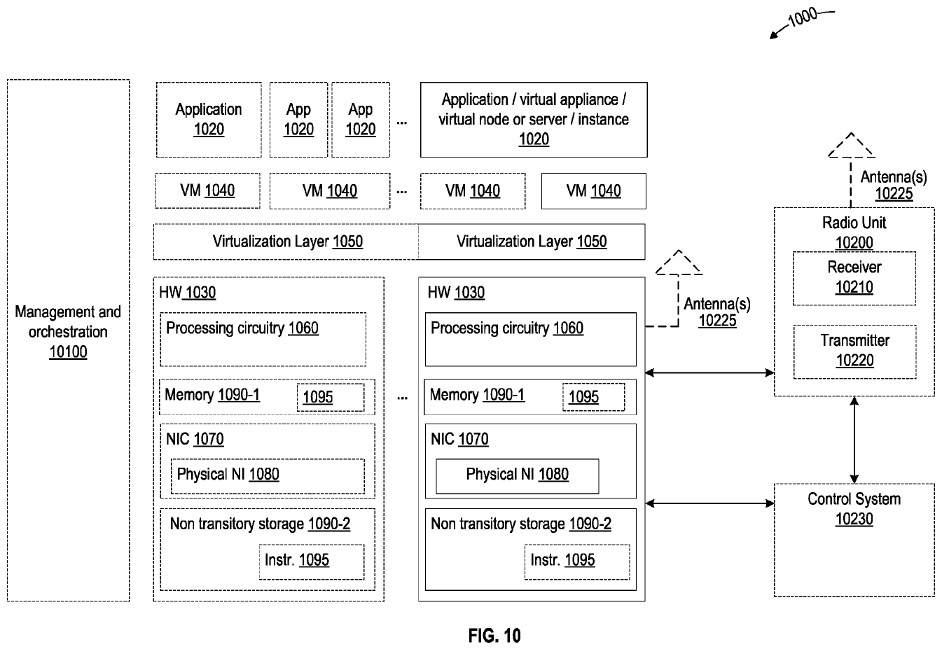

FIG. 10 is a schematic block diagram illustrating a virtualization environment 1000 in which functions implemented by some embodiments may be virtualized. In the present context, virtualizing means creating virtual versions of apparatuses or devices which may include virtualizing hardware platforms, storage devices, and networking resources. As used herein, virtualization can be applied to a node (e.g., a virtualized base station or a virtualized radio access node) or to a device (e.g., a UE, a wireless device, or any other type of communication device) or components thereof and relates to an implementation in which at least a portion of the functionality is implemented as one or more virtual components (e.g., via one or more applications, components, functions, virtual machines, or containers executing on one or more physical processing nodes in one or more networks).

In some embodiments, some or all of the functions described herein may be implemented as virtual components executed by one or more virtual machines implemented in one or more virtual environments 1000 hosted by one or more of hardware nodes 1030. Further, in embodiments in which the virtual node is not a radio access node or does not require radio connectivity (e.g., a core network node), then the network node may be entirely virtualized.

The functions may be implemented by one or more applications 1020 (which may alternatively be called software instances, virtual appliances, network functions, virtual nodes, virtual network functions, etc.) operative to implement some of the features, functions, and/or benefits of some of the embodiments disclosed herein. Applications 1020 are run in virtualization environment 1000 which provides hardware 1030 comprising processing circuitry 1060 and memory 1090. Memory 1090 contains instructions 1095 executable by processing circuitry 1060 whereby application 1020 is operative to provide one or more of the features, benefits, and/or functions disclosed herein.

Virtualization environment 1000 comprises general-purpose or special-purpose network hardware devices 1030 comprising a set of one or more processors or processing circuitry 1060, which may be commercial off-the-shelf (COTS) processors, dedicated Application Specific Integrated Circuits (ASICs), or any other type of processing circuitry including digital or analog hardware components or special purpose processors. Each hardware device may comprise memory 1090-1 which may be non-persistent memory for temporarily storing instructions 1095 or software executed by processing circuitry 1060. Each hardware device may comprise one or more network interface controllers (NICs) 1070, also known as network interface cards, which include physical network interface 1080. Each hardware device may also include non-transitory, persistent, machine-readable storage media 1090-2 having stored therein software 1095 and/or instructions executable by processing circuitry 1060. Software 1095 may include any type of software including software for instantiating one or more virtualization layers 1050 (also referred to as hypervisors), software to execute virtual machines 1040 as well as software allowing it to execute functions, features, and/or benefits described in relation with some embodiments described herein.

Virtual machines 1040 comprise virtual processing, virtual memory, virtual networking, or interface and virtual storage, and may be run by a corresponding virtualization layer 1050 or hypervisor. Different embodiments of the instance of virtual appliance 1020 may be implemented on one or more of virtual machines 1040, and the implementations may be made in different ways.

During operation, processing circuitry 1060 executes software 1095 to instantiate the hypervisor or virtualization layer 1050, which may sometimes be referred to as a virtual machine monitor (VMM). Virtualization layer 1050 may present a virtual operating platform that appears like networking hardware to virtual machine 1040.

As shown in FIG. 10, hardware 1030 may be a standalone network node with generic or specific components. Hardware 1030 may comprise antenna 10225 and may implement some functions via virtualization. Alternatively, hardware 1030 may be part of a larger cluster of hardware (e.g., such as in a data center or customer premise equipment (CPE)) where many hardware nodes work together and are managed via management and orchestration (MANO) 10100, which, among others, oversees lifecycle management of applications 1020.

Virtualization of the hardware is in some contexts referred to as network function virtualization (NFV). NFV may be used to consolidate many network equipment types onto industry standard high-volume server hardware, physical switches, and physical storage, which can be located in data centers and customer premise equipment.

In the context of NFV, virtual machine 1040 may be a software implementation of a physical machine that runs programs as if they were executing on a physical, non-virtualized machine. Each of virtual machines 1040 and that part of hardware 1030 that executes that virtual machine, be it hardware dedicated to that virtual machine and/or hardware shared by that virtual machine with others of the virtual machines 1040, forms a separate virtual network elements (VNE).

Still in the context of NFV, Virtual Network Function (VNF) is responsible for handling specific network functions that run in one or more virtual machines 1040 on top of hardware networking infrastructure 1030 and corresponds to application 1020 in FIG. 10.

In some embodiments, one or more radio units 10200 that each include one or more transmitters 10220 and one or more receivers 10210 may be coupled to one or more antennas 10225. Radio units 10200 may communicate directly with hardware nodes 1030 via one or more appropriate network interfaces and may be used in combination with the virtual components to provide a virtual node with radio capabilities, such as a radio access node or a base station.

In some embodiments, some signaling can be effected with the use of control system 8230 which may alternatively be used for communication between the hardware nodes 1030 and radio units 10200.

### Telecommunication Network Connected Via an Intermediate Network to a Host Computer in Accordance with Some Embodiments

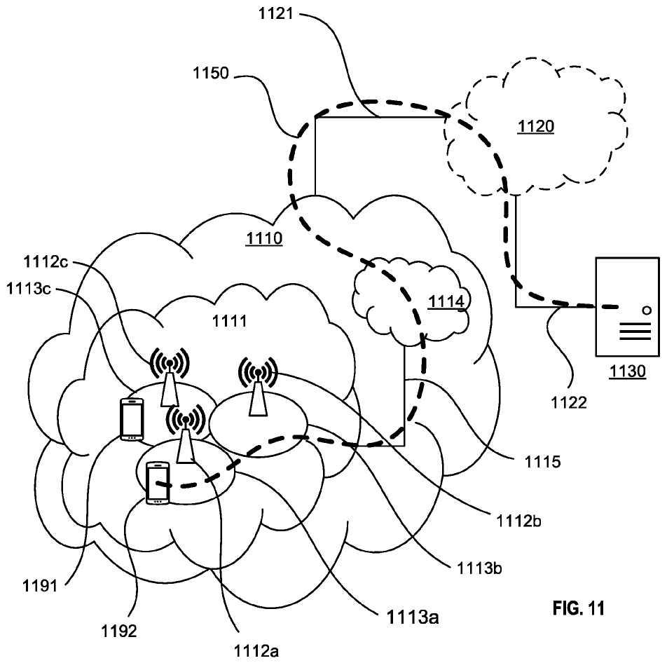

With reference to FIG. 11, in accordance with an embodiment, a communication system includes telecommunication network 1110, such as a 3GPP-type cellular network, which comprises access network 1111, such as a radio access network, and core network 1114. Access network 1111 comprises a plurality of base stations 1112a, 1112b, 1112c, such as NBs, eNBs, gNBs or other types of wireless access points, each defining a corresponding coverage area 1113a, 1113b, 1113c. Each base station 1112a, 1112b, 1112c is connectable to core network 1114 over a wired or wireless connection 1115. A first UE 1191 located in coverage area 1113c is configured to wirelessly connect to, or be paged by, the corresponding base station 1112c. A second UE 1192 in coverage area 1113a is wirelessly connectable to the corresponding base station 1112a. While a plurality of UEs 1191, 1192 are illustrated in this example, the disclosed embodiments are equally applicable to a situation where a sole UE is in the coverage area or where a sole UE is connecting to the corresponding base station 1112.

Telecommunication network 1110 is itself connected to host computer 1130, which may be embodied in the hardware and/or software of a standalone server, a cloud-implemented server, a distributed server or as processing resources in a server farm. Host computer 1130 may be under the ownership or control of a service provider, or it may be operated by the service provider or on behalf of the service provider. Connections 1121 and 1122 between telecommunication network 1110 and host computer 1130 may extend directly from core network 1114 to host computer 1130 or may go via an optional intermediate network 1120. Intermediate network 1120 may be one of, or a combination of more than one of a public, private or hosted network; intermediate network 1120, if any, may be a backbone network or the Internet; in particular, intermediate network 1120 may comprise two or more sub-networks (not shown).

The communication system of FIG. 11 as a whole enables connectivity between the connected UEs 1191, 1192 and host computer 1130. The connectivity may be described as an over-the-top (OTT) connection 1150. Host computer 1130 and the connected UEs 1191, 1192 are configured to communicate data and/or signaling via OTT connection 1150, using access network 1111, core network 1114, any intermediate network 1120 and possible further infrastructure (not shown) as intermediaries. OTT connection 1150 may be transparent in the sense that the participating communication devices through which OTT connection 1150 passes are unaware of routing of uplink and downlink communications. For example, base station 1112 may not or need not be informed about the past routing of an incoming downlink communication with data originating from host computer 1130 to be forwarded (e.g., handed over) to a connected UE 1191. Similarly, base station 1112 need not be aware of the future routing of an outgoing uplink communication originating from the UE 1191 towards the host computer 1130.

Some of the embodiments contemplated herein above are described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

The term unit may have conventional meaning in the field of electronics, electrical devices, and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

1. A method to support Authentication and Key Management for Applications (AKMA) in a wireless network, wherein AKMA provides an authentication and key distribution service to a subscriber of the wireless network to access to an application server based on cellular subscription of the subscriber, the method comprising:
transmitting a query that includes an identifier of the subscriber and that requires information on AKMA allowability of the subscriber to a database; and
receiving an indication of AKMA allowability of the subscriber responsively, wherein the indication of AKMA allowability is provided based on retrieval of information for the subscriber stored in the database.

2. The method of claim 1, wherein the information for the subscriber stored in the database comprises a Boolean data entry, one value of which indicates that the subscriber is allowed to use AKMA, and an opposite value indicating that the subscriber is not allowed to use AKMA.

3. The method of claim 1, wherein the information for the subscriber stored in the database is stored in an Information Element (IE) that is to indicate AKMA allowability of the subscriber.

4. The method of claim 1, wherein the information for the subscriber stored in the database is stored as a part of authentication subscription data for the subscriber, wherein the authentication subscription data for the subscriber further comprises an authentication method, an encryption value of a permanent authentication key, a protection parameter identifier that identifies a parameter set that can be used to decrypt the permanent authentication key, and an algorithm identifier to identify a parameter set that provides details on algorithm and parameters used to generate one or more authentication vectors to authenticate the subscriber.

5. The method of claim 4, wherein the query is transmitted to the database in responsive to receiving an authentication request for the subscriber, wherein the authentication request is generated for the subscriber during a primary authentication initialization of the subscriber with an Authentication Server Function (AUSF).

6. The method of claim 5, wherein the one or more authentication vectors and the indication of AKMA allowability of the subscriber are provided to the AUSF, which, when the indication of AKMA allowability of the subscriber indicates allowability being true, generates AKMA key materials including a AKMA key and an AKMA key identifier (A-KID) after a successfully completed primary authentication.

7. The method of claim 6, wherein the one or more authentication vectors and the indication of AKMA allowability of the subscriber are provided to the AUSF, which, when the indication of AKMA allowability of the subscriber indicates allowability being false, continues primary authentication of the subscriber and without generating the AKMA key materials after the successfully completed primary authentication.

8. The method of claim 6, wherein the AUSF transmits the AKMA key materials to an AKMA Anchor Function (AAnF), which acknowledges with a register response upon receipt of the AKMA key materials.

9. The method of claim 1, wherein the indication of AKMA allowability of the subscriber is provisioned through a management interface of the wireless network.

10. The method of claim 1, wherein provisioning of the indication of AKMA allowability of the subscriber uses a business support system (BSS) of the wireless network.

11. The method of claim 1, wherein the identifier of the subscriber is one of a subscription permanent identifier (SUPI) or a subscription concealed identifier (SUCI).

12. The method of claim 1, wherein electronic device implements a unified data management (UDM) entity or a network exposure function (NEF) to perform the transmitting the query and receiving the indication of AKMA allowability of the subscriber.

13. The method of claim 1, wherein the database is implemented in a unified data repository (UDR) that stores the information for the subscriber based on which the indication of AKMA allowability is provided.

14. A network node to support Authentication and Key Management for Applications (AKMA) in a wireless network, wherein AKMA provides an authentication and key distribution service to a subscriber of the wireless network to access to an application server based on cellular subscription of the subscriber, the network node comprising:
a processor and non-transitory machine-readable storage medium that provides instructions that, when executed by the processor, cause the network node to perform:
transmitting a query that includes an identifier of the subscriber and that requires information on AKMA allowability of the subscriber to a database; and
receiving an indication of AKMA allowability of the subscriber responsively, wherein the indication of AKMA allowability is provided based on retrieval of information for the subscriber stored in the database.

15. The network node of claim 14, wherein the information for the subscriber stored in the database comprises a Boolean data entry, one value of which indicates that the subscriber is allowed to use AKMA, and an opposite value indicating that the subscriber is not allowed to use AKMA.

16. The network node of claim 14, wherein the information for the subscriber stored in the database is stored in an Information Element (IE) that is to indicate AKMA allowability of the subscriber.

17. The network node of claim 14, wherein the information for the subscriber stored in the database is stored as a part of authentication subscription data for the subscriber, wherein the authentication subscription data for the subscriber further comprises an authentication method, an encryption value of a permanent authentication key, a protection parameter identifier that identifies a parameter set that can be used to decrypt the permanent authentication key, and an algorithm identifier to identify a parameter set that provides details on algorithm and parameters used to generate one or more authentication vectors to authenticate the subscriber.

18. The network node of claim 17, wherein the query is transmitted to the database in responsive to receiving an authentication request for the subscriber, wherein the authentication request is generated for the subscriber during a primary authentication initialization of the subscriber with an Authentication Server Function (AUSF).

19. The network node of claim 18, wherein the one or more authentication vectors and the indication of AKMA allowability of the subscriber are provided to the AUSF, which, when the indication of AKMA allowability of the subscriber indicates allowability being true, generates AKMA key materials including a AKMA key and an AKMA key identifier (A-KID) after a successfully completed primary authentication.

20-26. (canceled)

27. A non-transitory machine-readable storage medium that provides instructions that, when executed by a processor, cause a network node to perform:
transmitting query that includes an identifier of a subscriber of a wireless network and that requires information on Authentication and Key Management for Applications (AKMA) allowability of the subscriber to a database, wherein AKMA provides an authentication and key distribution service to the subscriber to access to an application server based on cellular subscription of the subscriber; and
receiving an indication of AKMA allowability of the subscriber responsively, wherein the indication of AKMA allowability is provided based on retrieval of information for the subscriber stored in the database.

28-39. (canceled)
